(19) United States
(12) Patent Application Publication
(10) Pub. No.: US 2009/0125556 A1
(43) Pub. Date: May 14, 2009

(54) Website for presenting videos related to homes for sale and other places of interest within a specified region

(76) Inventors: Sandra M. Naroian, Bolton, MA (US); James A. Shiner, North Reading, MA (US); Gregory K. Afarian, North Andover, MA (US)

Correspondence Address: Russ Weinzimmer, 614 Nashua Street, Suite 53, Milford, NH, 03055, US

(21) Appl. No.: 11/983,659

(22) Filed: Nov. 10, 2007

(51) Int. Cl. G06F 17/30

(52) U.S. Cl. 707/104.1; 707/E17.032

(57) ABSTRACT

A website is disclosed exclusively for distributing videos relating to homes for sale or rent, restaurants, schools, hotels, museums, tourist attractions, and other places of interest within a specified region. The website includes a database of videos and related information, a home webpage where location information such as a zip code or address and other specific characteristics are entered, and a second webpage where a list of places of interest that satisfy the specified criteria is presented, and where in some embodiments the search can be narrowed. In one aspect, the home webpage allows only input of location information. Preferred embodiments allow definition of a region according to a maximum distance or travel time from a location. Some embodiments display locating information and/or videos and other information regarding real estate agents or other subscribers. Preferred embodiments also provide for linking or embedding of videos in email, blogs, other websites, etc.

### FIELD OF THE INVENTION

The invention generally relates to interactive websites, and more specifically to websites that facilitate the distribution of videos over the world-wide web regarding homes for sale and other places of interest.

### BACKGROUND OF THE INVENTION

Millions of Americans buy and sell homes each year. While purchasing a new home can be an exciting and exhilarating experience, it can also be a stressful and time consuming process, involving detailed study of home specifications and photographs, and visits to many properties.

Very often, buying a new home is motivated by a need to live close to a new place of employment, the home of a relative, an exceptional public school system, or another location-specific desire or need. Services are available that provide addresses, list prices, photographs, and other information regarding homes for sale in a specified region. However, it is generally not possible to fully evaluate the desirability of a home that is for sale without visiting the home in person, or at least viewing a walkthrough video of the home.

Many companies now offer commercial production of video home walkthroughs to assist in buying and selling real estate. These are sometimes distributed to real estate agents and potential buyers on tape, DVD, and other media, or on dedicated real estate computer networks. Some are posted on the worldwide web, often on general interest video posting sites such as Google.com or YouTube.com that are not specific to real estate and are not location specific. Others are posted on websites that specialize in real estate information but do not require listings to be accompanied by videos. A user seeking videos of homes for sale is therefore required when visiting these websites to sort through a large amount of unrelated information and irrelevant web pages in order to locate a video of a real estate property that is for sale within a desired region. Even websites that limit themselves to videos of real estate for sale typically require a user to navigate through one or more web pages before initiating a search. In addition, they often present the user with a lengthy set of required and optional input fields, as well as a key word search that can provide uncertain and inconsistent results depending on the expertise of the user in choosing optimal key words.

A similar situation exists for other categories of places of interest that relate to specific locations or regions. A person may be seeking a school for his or her children, an apartment to rent, a hotel for a vacation, a restaurant with just the right ambiance, or a boutique or other specialty store with just the right types of merchandise. In all cases, it can be time consuming, frustrating, or impractical to visit all of the candidate locations in person, and yet it is nearly impossible to fully evaluate such candidate locations without a visit, or at least without viewing a video walk-through of the location. While some walk-through videos are available on the worldwide web, they are often found on general interest sites and/or on sites where videos are not required and where locating a video relating to place of interest within a region of interest is cumbersome and complicated.

### SUMMARY OF THE INVENTION

A website is disclosed that is devoted exclusively to providing videos relating to places of interest within a specified region of interest. In one aspect of the invention, the website includes a database, a home webpage, and a second webpage. The database contains only videos related to places of interest and supporting information applicable to the videos. The home webpage simplifies the process of searching the database by accepting only location information in a first restricted input field and search criteria specifying at least one specific characteristic relating to a place of interest in a second restricted input field. The second webpage is linked from the homepage and displays a list of places of interest from the database as selected according to the location information and the at least one specific characteristic.

In preferred embodiments, the places of interest are homes for sale, homes for rent, restaurants, schools, hotels, museums, tourist attractions, and/or other places of interest. In some preferred embodiments, the home webpage includes means for specifying a distance or a travel time, and the region of interest is defined as all locations that lie within the specified distance or specified travel time of a specified zip code, town or city and state, address, latitude and longitude, etc.

In preferred embodiments, the location information is a zip code, a city and state, or a town and state. In further preferred embodiments, once a user has selected a place of interest from a displayed list, the website also provides a list of other places of interest for which videos are available in the database.

In some preferred embodiments, the second webpage allows the search to be narrowed by providing at least one restricted input field for inputting additional search criteria specifying at least one specific characteristic relating to places of interest, so as to provide for selecting places of interest from the database according to the location information and the at least one specific characteristic input on the home webpage and the at least one specific characteristic input on the second webpage.

In preferred embodiments, additional websites display videos selected by users, information that enables a user to locate a place of interest, and information regarding a real estate agent or other subscriber who has provided a video to the database. In further preferred embodiments, administrative web pages are also included that provide means for individuals to register as subscribers, and for subscribers to log into the website and to upload, add to, delete from, and edit videos in the database and supporting information applicable to the videos.

In another aspect of the invention, the website includes a database, a home webpage, and a second webpage. The database contains only videos related to places of interest and supporting information applicable to the videos. The home webpage simplifies the process of searching the database by accepting only location information in a restricted input field. The second webpage is linked from the homepage and displays a list of places of interest from the database as selected according to the location information.

In preferred embodiments, the places of interest are homes for sale, homes for rent, restaurants, schools, hotels, museums, tourist attractions, and/or other places of interest. In some preferred embodiments, the home webpage includes means for specifying a distance or a travel time, and the region of interest is defined as all locations that lie within the specified distance or specified travel time of a specified zip code, town or city and state, address, latitude and longitude, etc.

In preferred embodiments, the location information is a zip code, a city and state, or a town and state. In further preferred embodiments, once a user has selected a place of interest from a displayed list, the website also provides a list of other places of interest for which videos are available in the database.

In some preferred embodiments, the second webpage allows the search to be narrowed by providing at least one restricted input field for inputting additional search criteria specifying at least one specific characteristic relating to places of interest, so as to provide for selecting places of interest from the database according to the location information and the at least one specific characteristic input on the home webpage and the at least one specific characteristic input on the second webpage.

In preferred embodiments, information that enables the user to locate a selected place of interest is also displayed. In further preferred embodiments, administrative web pages are also included that provide means for individuals to register as subscribers, and for subscribers to log into the website and to upload, add to, delete from, and edit videos in the database and supporting information applicable to the videos.

### BRIEF DESCRIPTION OF THE DRAWINGS

FIG. 1A presents a home webpage of a preferred embodiment that only allows input of a zip code, city, or town as search criteria;

FIG. 1B presents the home webpage of a preferred embodiment that allows specification of a distance or travel time in addition to location or region defining input as search criteria;

FIG. 1C presents the home webpage of a preferred embodiment that allows specification of characteristics of a place of interest in addition to region defining information;

FIG. 2A presents the second webpage of a preferred embodiment that presents a list of places of interest and pictures of the places of interest;

FIG. 2B presents the second page of a preferred embodiment that presents a list of places of interest with selected characteristics, and that allows the search to be narrowed by specifying additional characteristics of places of interest;

FIG. 3 presents the third webpage of a preferred embodiment;

FIG. 4 presents a preferred embodiment administrative webpage that provides for registering an individual as a new subscriber;

FIG. 5 presents a preferred embodiment administrative webpage that welcomes a new subscriber and presents options for performing administrative tasks;

FIG. 6 presents a preferred embodiment administrative webpage that provides for a registered subscriber to log onto the website;

FIG. 7 presents a preferred embodiment administrative webpage that provides options for performing video-related tasks;

FIG. 8 presents a preferred embodiment administrative webpage that allows a subscriber to upload a video and related information to the database;

FIG. 9 presents a preferred embodiment administrative webpage that allows a subscriber to upload additional information related to a video to the database;

FIG. 10 presents a preferred embodiment administrative webpage that allows a subscriber to provide a description of a home for sale, details regarding an open house relating to the home for sale, and that also provides a means for a subscriber to delete a video and related information from the database;

FIG. 11 presents a preferred embodiment administrative webpage that allows a real estate agent or other subscriber to provide details about himself or herself for display to a user when a video uploaded by the subscriber is selected by the user;

FIG. 12 presents a flow diagram illustrating access by a user of a video related to a place of interest within a region of interest;

FIG. 13 presents a flow diagram illustrating access by a user of a video related to a home for sale within a region of interest; and

FIG. 14 presents a flow diagram illustrating the registration of a new subscriber, logging in of a previously registered subscriber, and performing of administrative tasks by a subscriber.

### DETAILED DESCRIPTION OF PREFERRED EMBODIMENTS

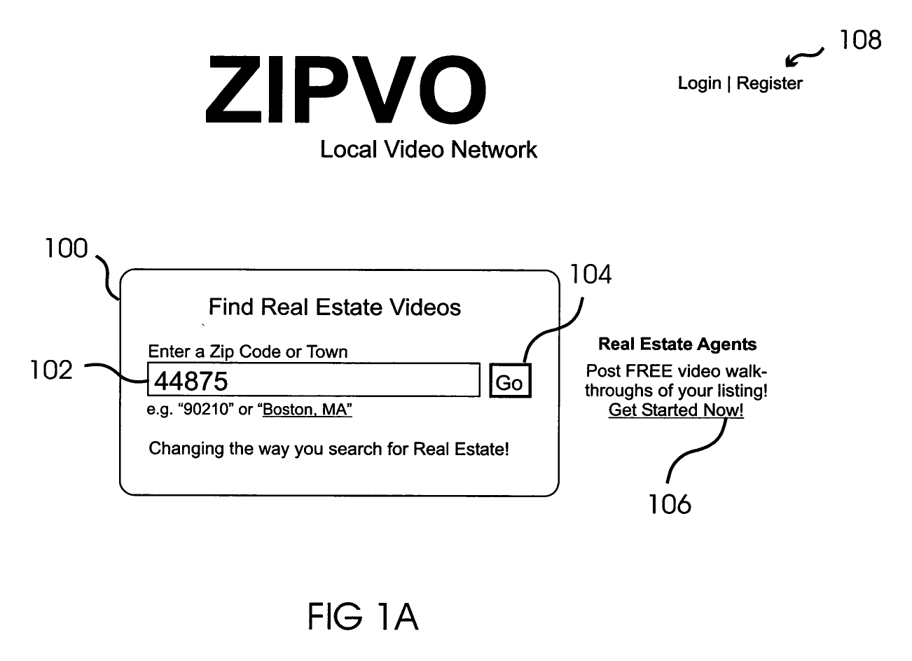

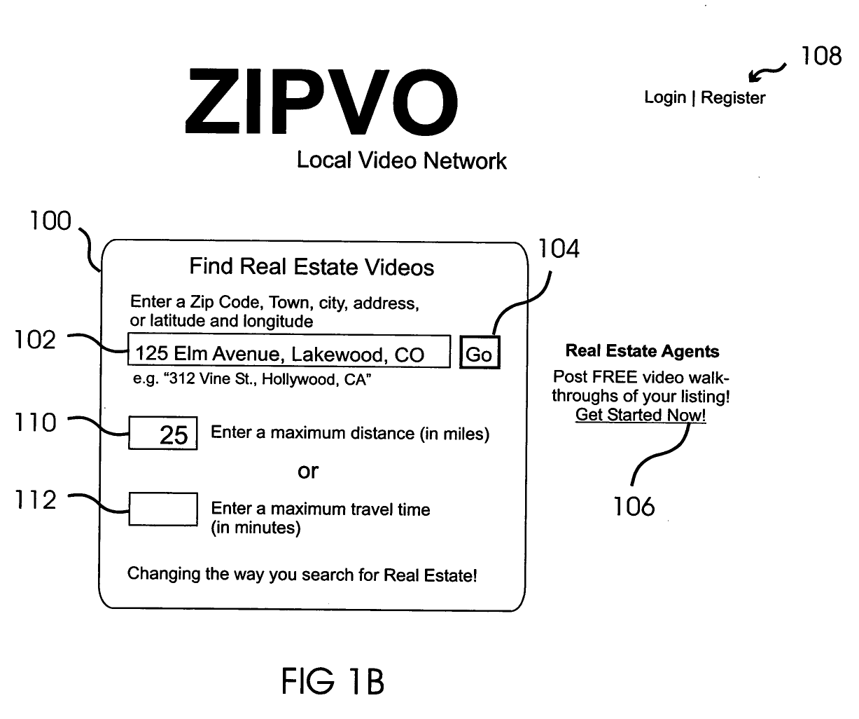

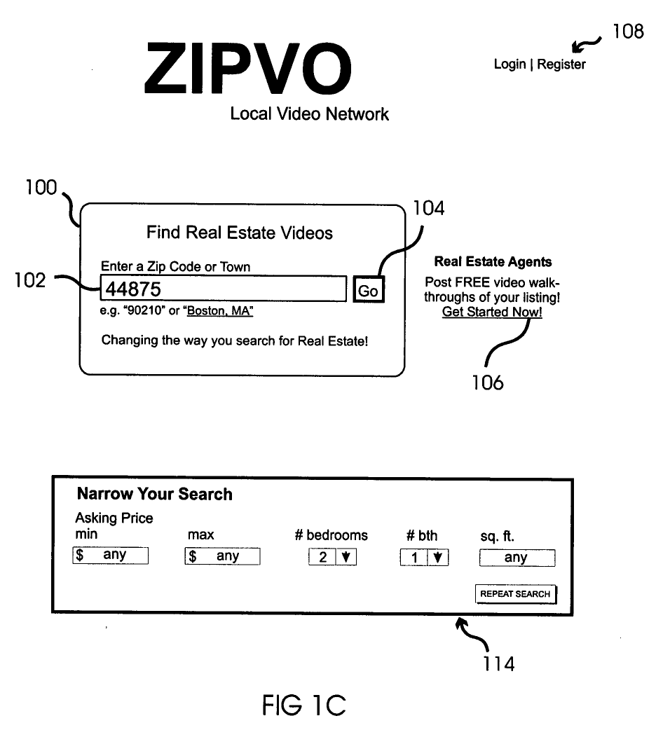

With reference to FIG. 1A, website of the invention is devoted exclusively to providing videos relating to places of interest within a specified region of interest, together with supporting information applicable to the videos. The home webpage of the invention simplifies the process of finding videos by requiring only that a user define a region of interest so as to initiate a search for videos. In the embodiment of FIG. 1A, a region defining area 100 is presented, into which a user enters either a zip code or a town or city and state 102, and then initiates a search of the database for videos relating to places of interest in that region by using the mouse to click on a button labeled “Go” 104. In this embodiment, the places of interest are real estate videos. Opportunities are also presented 106, 108 for real estate agents to be directed to administrative web pages so as to become subscribers, log in, and perform other administrative tasks. In embodiments not limited to real estate, a similar opportunity is provided for any user to become a subscriber, and for subscribers to perform administrative tasks.

With reference to FIG. 1B, in another preferred embodiment the home webpage allows a user to enter a zip code, a town or city and state, or an address 102, together with a distance 110 or a travel time 112, so that the region of interest is defined as all locations that are within the specified distance 110 or travel time 112 of the specified zip code, town or city and state, or address 100. If no distance 110 or travel time 112 is entered, the region of interest is defined to be all locations that are within the specified zip code or town or city and state 100. Entering a specific address 100 without entering a distance 110 or travel time 112 generates an error message, unless the database contains a video related to the specific address, in which case the third webpage is immediately displayed (see below) and the video is presented.

FIG. 1C illustrates the home webpage of a preferred embodiment that presents an opportunity 114 to narrow the search by specifying additional search characteristics of a desired home for sale, such as a range of list prices, a desired number of bedrooms, a desired number of bathrooms, and a desired minimum square footage. In embodiments not limited to real estate, preferred embodiments offer an opportunity to narrow a search for places of interest by selecting a category of places of interest from a list, such as hotels, museums, restaurants, etc.

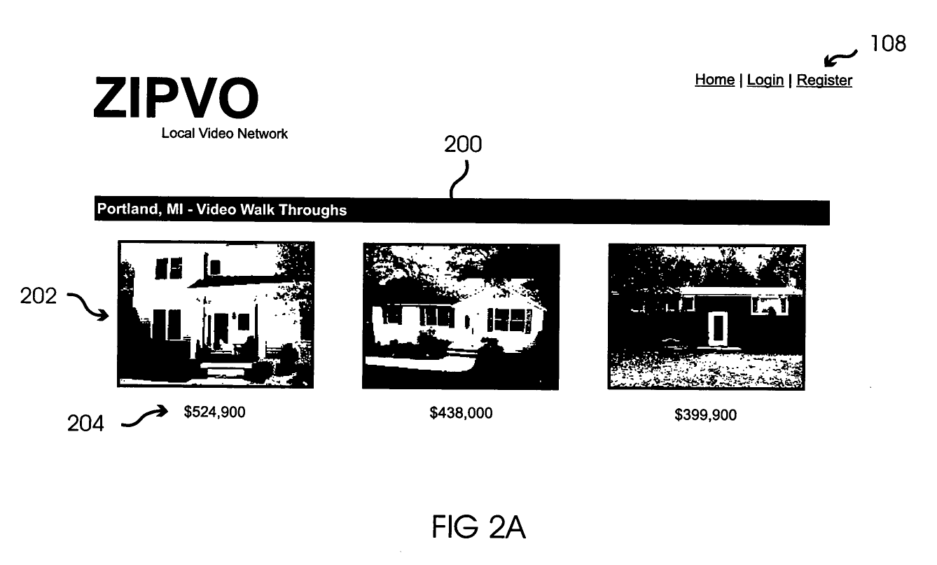

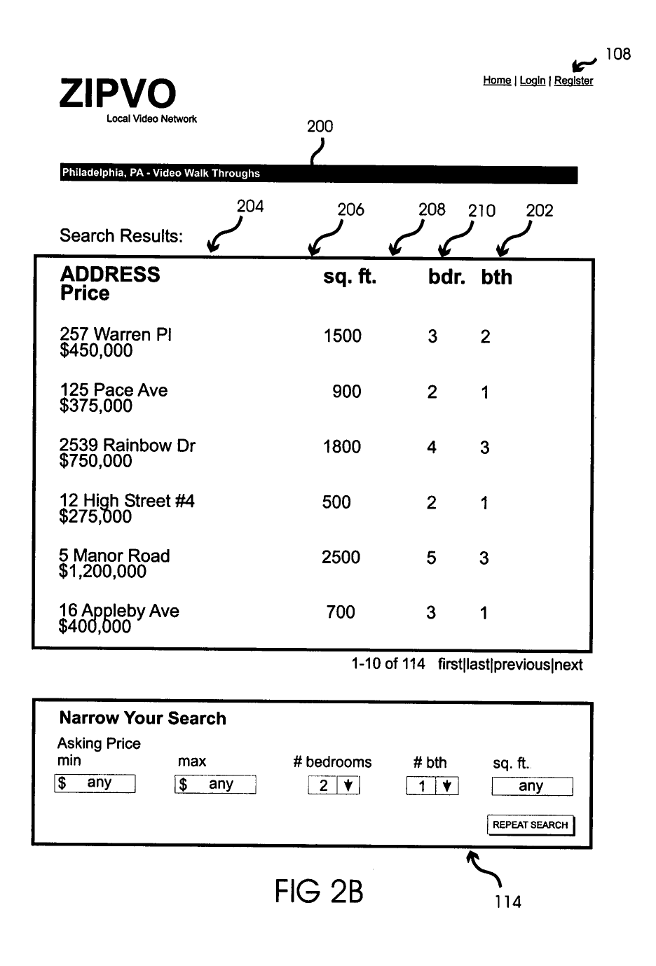

FIG. 2A illustrates the second webpage of a preferred embodiment, which is presented after a user specifies a region of interest on the home webpage. In this embodiment, a series of photographs of homes for sale 200, together with list prices 202, is presented. The user can choose to see the video walkthrough of one of the homes by clicking with the mouse on the associated photograph 100. In embodiments not limited to real estate, the second webpage of the invention presents lists of places of interest and supporting information, such as restaurants with typical meal costs, hotels with typical room costs, apartments for rent with rental rates, etc.

FIG. 2B presents the second webpage of a preferred embodiment in which a list of results 204 is presented without photographs, but including for each listing the square footage 206, number of bedrooms 208, and number of bathrooms 210 as well as the asking price 202. In this embodiment, an opportunity is presented 114 on the second webpage similar to the opportunity shown in FIG. 1C to narrow the search by specifying additional search characteristics of a desired home for sale, such as a range of list price, desired number of bedrooms, desired number of bathrooms, and desired minimum square footage.

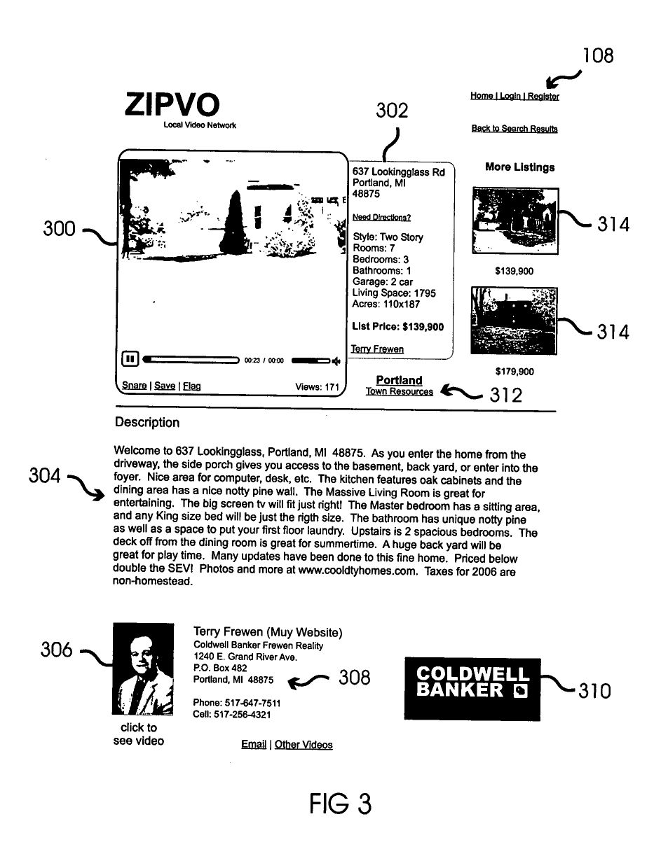

FIG. 3 presents the third webpage of a preferred embodiment. This webpage presents a video 300 of a home for sale selected by the user from the second webpage. In preferred embodiments, this webpage can also be reached from the first webpage by entering the specific address of a place of interest for which a video is contained in the database, or by navigating directly to a specific web address. For example, if a certain video has a record number 23679 in the database, and if an individual has obtained the record number by seeing it in a printed advertisement or on a sign posted at the home for sale, then in a preferred embodiment the individual can navigate directly to the third webpage and view video 23679 by entering the web address “http://www.zipvo.com/23679” into a web browser.

The third webpage in this embodiment also presents locating information for the home for sale 302, a description of the home for sale 304, and a photograph 306 and other information 308 regarding the real estate agent who uploaded the video 300 of the home for sale. If the user clicks on the photograph 306 of the real estate agent, a video about the real estate is displayed. In this embodiment, the logo of the real estate company 310 that the real estate agent belongs to is also presented, as well as photographs and list prices 312 of other homes for sale for which the same real estate agent (or in other embodiments the same real estate company) has uploaded videos. Similar embodiments include links to other information relevant to the region of interest, such as a list of city or town resources and information helpful for planning a move into or out of the region, as well providers of services to the region of interest such as mortgage brokers, electricians, plumbers, etc. Other embodiments include opportunities to initiate a dialog with a real estate agent or similar individual through a “click-to-talk” session, a text message exchange, or an “instant message” session.

In other preferred embodiments not limited to real estate, the third webpage of the invention presents a video walkthrough of a selected place of interest, such as a restaurant, hotel, apartment for rent, tourist attraction, etc, together with information allowing the user to locate the place of interest and other supporting information.

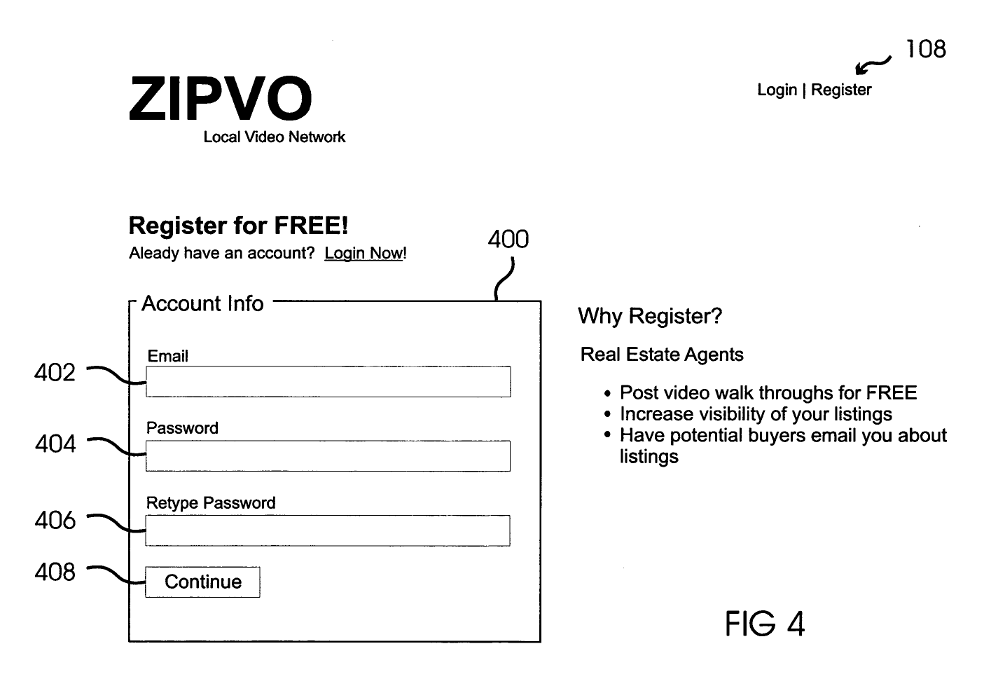

FIG. 4 presents a new subscriber registration administrative webpage of a preferred embodiment. A registration region 400 is presented containing windows in which a new subscriber enters an email address 402 (which in this embodiment serves as the subscriber's user name), a password 404, and a password repetition 406 (for verification of correct entry). The new subscriber then causes the information to be recorded and moves on to the next administrative website by clicking on a “continue” button 408.

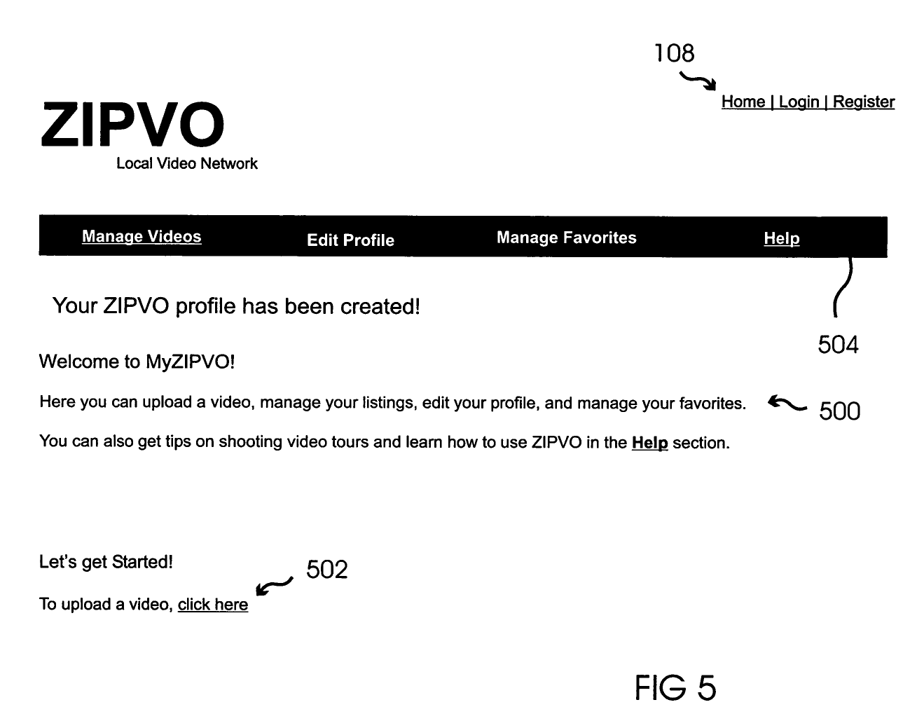

FIG. 5 presents the administrative webpage that is presented to a new subscriber upon completing the information requested by the webpage of FIG. 4 and clicking on “continue” 408. Along with a welcome message 500, the webpage offers the opportunity to upload a video 502, as well as a menu of other administrative tasks 504 available to the new subscriber.

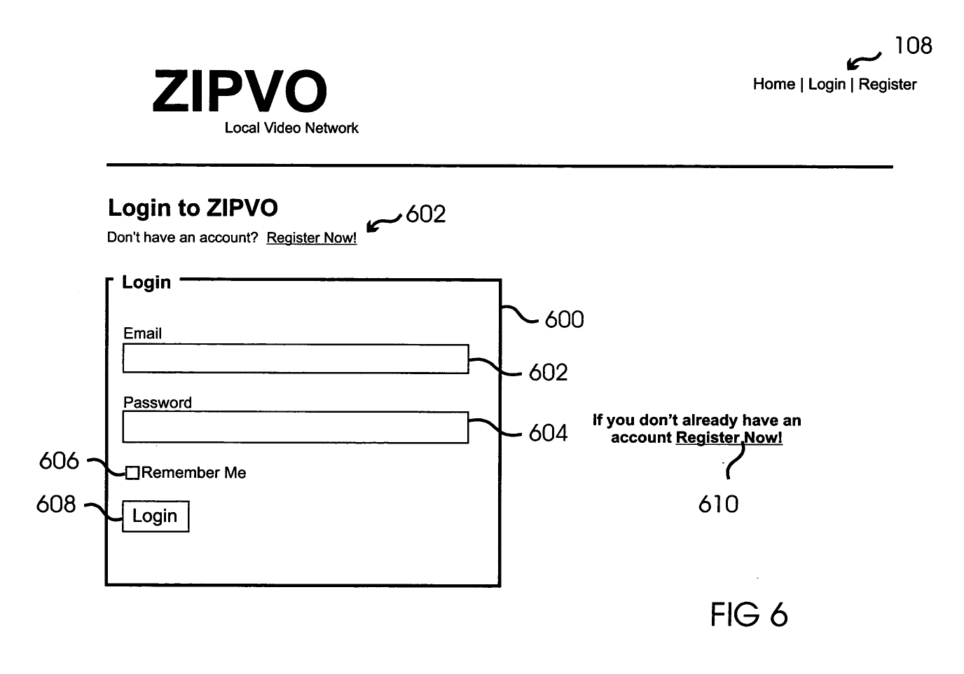

FIG. 6 presents an administrative webpage of a preferred embodiment that provides for a registered subscriber to log onto the website. This webpage would be presented, for example, if a subscriber clicked on the word “Login” 108 on the home webpage of FIG. 1. A region 600 is presented that includes windows for the subscriber to enter an email address 602 (used in this embodiment as a user name) and a password 604. A checkbox 606 with the label “Remember Me” is also provided, which if selected will cause a “cookie” to be deposited on the user's computer so that in the future the email address will be automatically filled in. The login process is then initiated by clicking on the “Login” button 608. Individuals who have not yet registered as subscribers are invited to go to the new subscriber webpage (FIG. 4) by clicking on the appropriate link labeled “Register Now” 610.

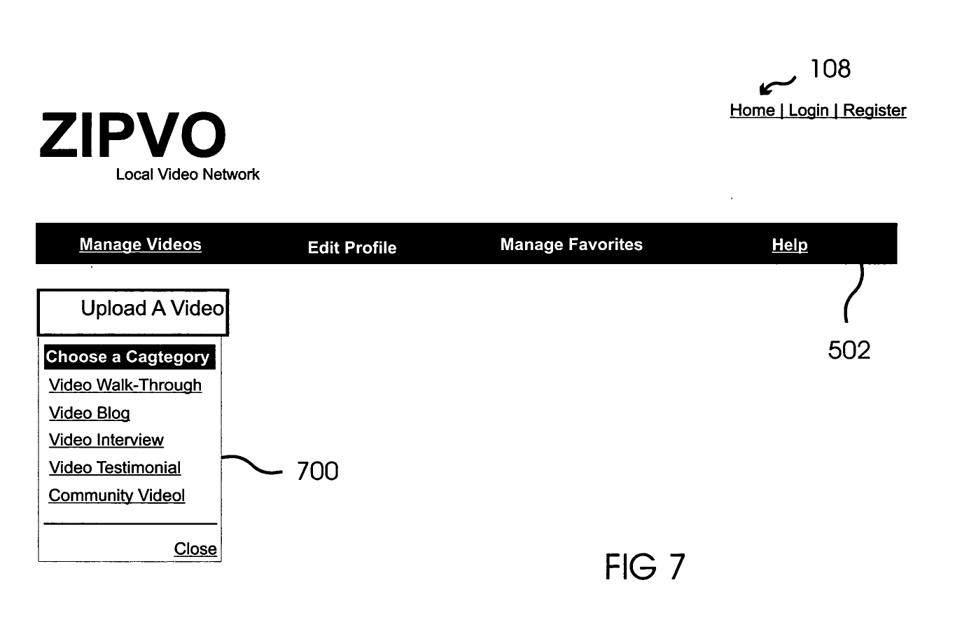

FIG. 7 presents the webpage that appears upon clicking on the “Manage Videos” link on the administrative tasks menu 502 in the embodiment of FIG. 5. A menu of video-related administrative tasks is presented, which in this embodiment includes management of a video walkthrough, a blog, an interview, a testimonial, and a community video.

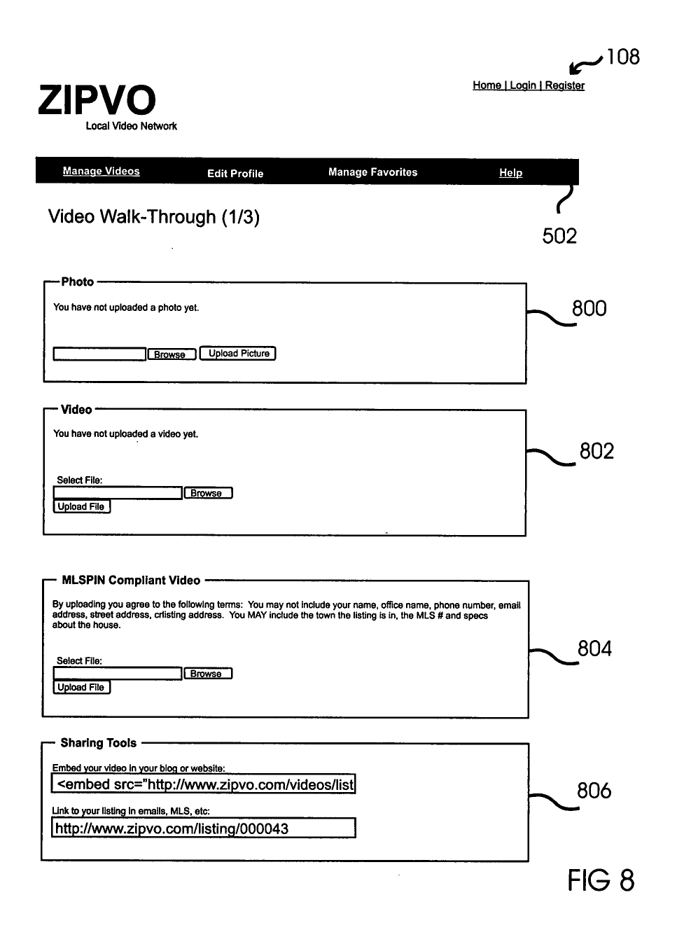

FIG. 8 presents the webpage that appears upon clicking on the “video walkthrough” link of FIG. 7. Opportunities are presented to upload a photograph 800, a general format video 802, an MLS compliant video 804, and also to embed an uploaded video in a website or blog, or link it to emails, MLS listings, etc 806. Similar websites are included in embodiments that allow for uploading of videos related to restaurants, hotels, tourist attractions, and other places of interest, except that some specific items such as an MLS compliant video do not apply.

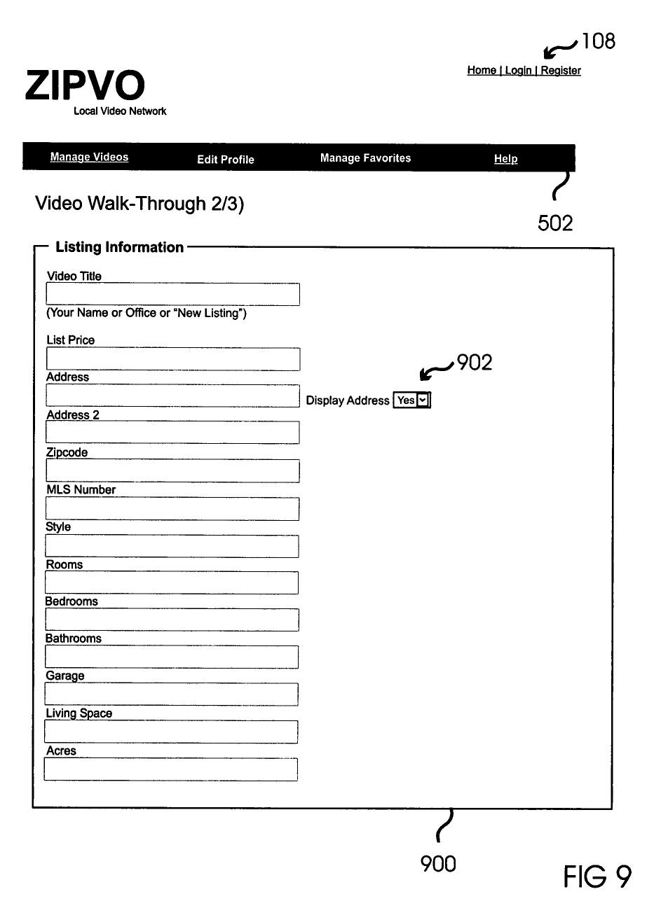

FIG. 9 presents the webpage that appears when the webpage of FIG. 8 is completed. It invites the subscriber to enter a title, address, and other information 900 pertaining to an uploaded video. It also provides an option 902 to display or not display the address of the place of interest to users that view the video.

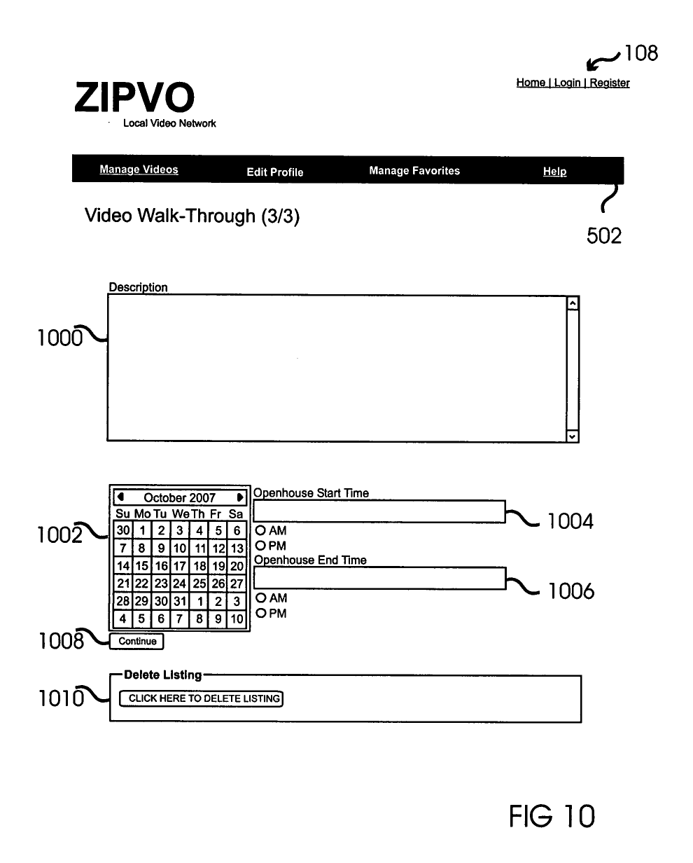

FIG. 10 presents the webpage that appears when the webpage of FIG. 9 is completed. It allows the subscriber to enter a text description of an uploaded video 1000, and also to enter details regarding an open house during which the home for sale will be available for viewing by prospective buyers, including the date specified on a calendar 1002 and the start time 1004 and the stop time 1006. In preferred embodiments that provide for the display of videos pertaining to tourist attractions, restaurants, libraries, etc., a similar calendar 1002, start time window 1004, and stop time window 1006, are used to specify days and times when the place of interest is open and available for use. The information is sent to the website by clicking on a “continue” button 1008. This webpage also provides an opportunity to delete a video listing 1010 (i.e. a video and all related information) from the database of the website.

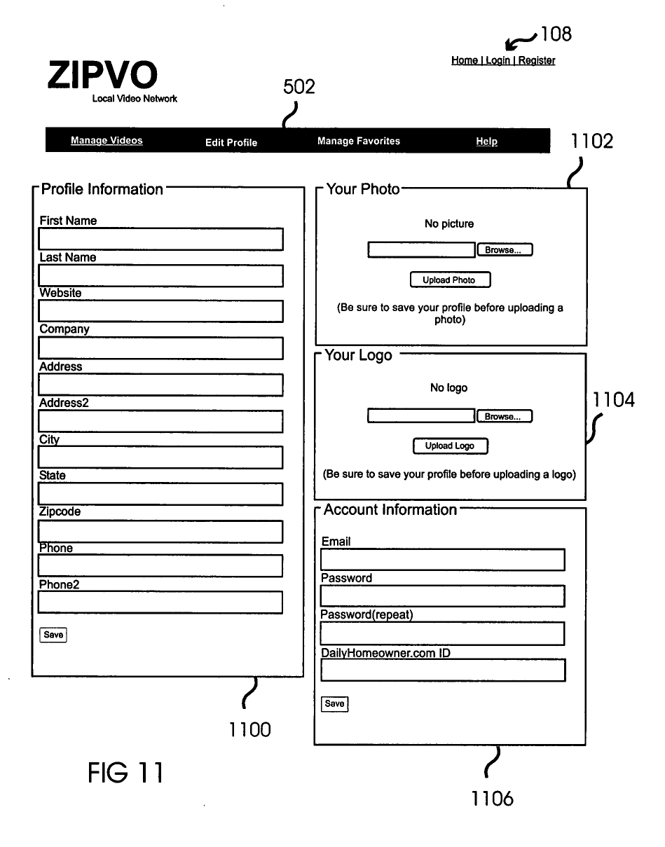

FIG. 11 presents an administrative webpage of a preferred embodiment that allows a subscriber to enter and edit personal information, including information that is displayed to a user when the user views a video uploaded by the subscriber. This webpage is reached, for example, by clicking on the “Edit Profile” link in the administrative menu 502 of FIG. 5. The webpage includes a region 1100 where name, address, company, website, and other personal information is entered, as well as regions where a photograph can be uploaded 1102, a logo can be uploaded 1104, and the subscriber's login email address and password can be edited 1106. This information can be useful, for example, when a user wishes to sell a house, and is interested in using the services of a real estate agent who is already representing sellers in the same or a similar area and who demonstrates skill in presenting houses for sale.

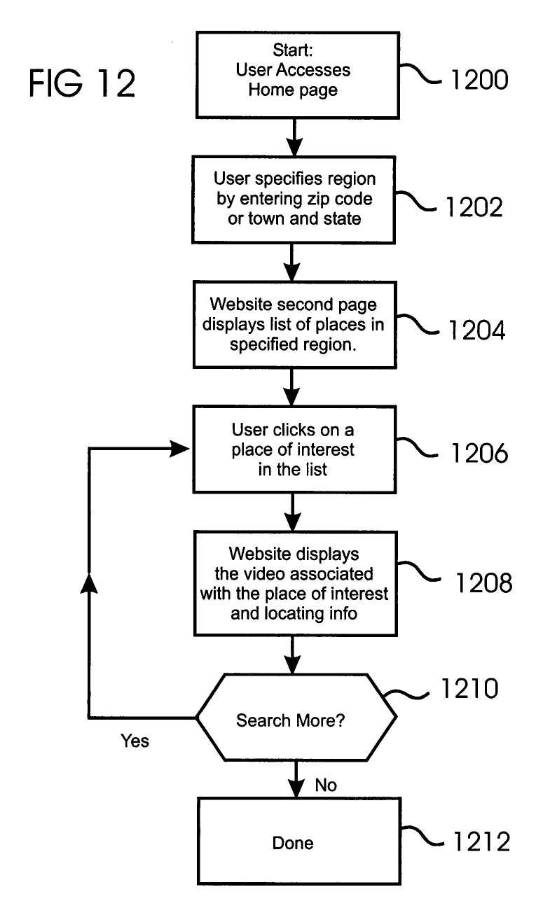

FIG. 12 presents a flow diagram for a preferred embodiment illustrating how a user locates and views a video pertaining to a place of interest. The user begins by accessing the home webpage of the invention 1200, and entering a zip code, town or city and state, or other required region defining information 1202. The second webpage of the invention is then displayed 1204, which presents a list of videos relating to places of interest that are located within the defined region of interest. By clicking on one of the places of interest in the list 1206, the user causes the third webpage of the invention to appear, and the video associated with the selected place of interest to be presented, along with supporting information such as how to locate the selected place of interest 1208. The user may then choose 1210 to select more places of interest from the list on the second webpage 1206, or end the search 1212.

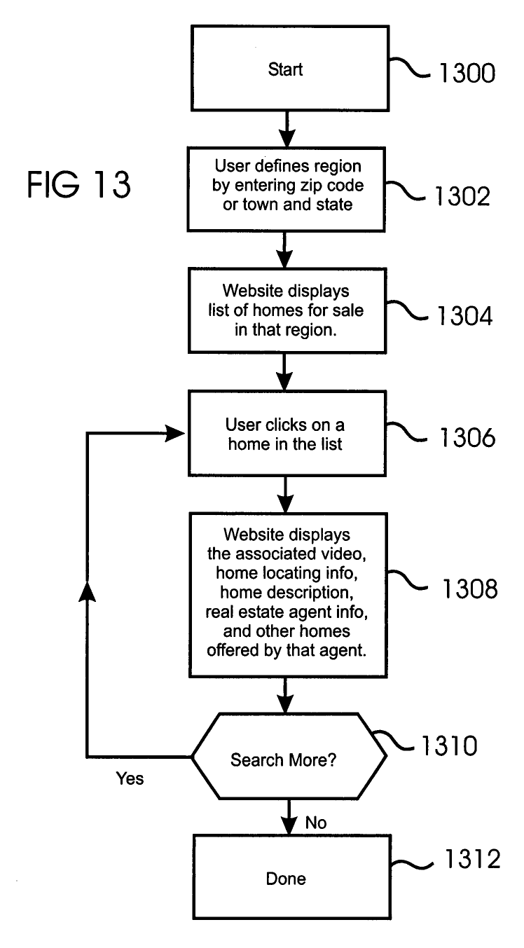

FIG. 13 is similar to FIG. 12, except that it applies specifically to an embodiment of the invention that presents videos relating to homes for sale. The user begins by accessing the home webpage of the invention 1300, and entering a zip code, town or city and state, or other required region defining information 1302. The second webpage of the invention is then displayed 1304, which presents a list of homes for sale that are located within the defined region of interest. By clicking on one of the homes for sale in the list 1306, the user causes the third webpage of the invention to appear, and the video associated with the selected home for sale to be presented 1308. The third webpage also presents 1308 supporting information such as how to locate the selected home for sale, a written description of the home for sale, information pertaining to the real estate agent that uploaded the video, and a list of other homes for sale for which the same real estate agent has also uploaded videos. The user may then choose 1310 to select more homes for sale from the list on the second webpage 1306, or end the search 1312.

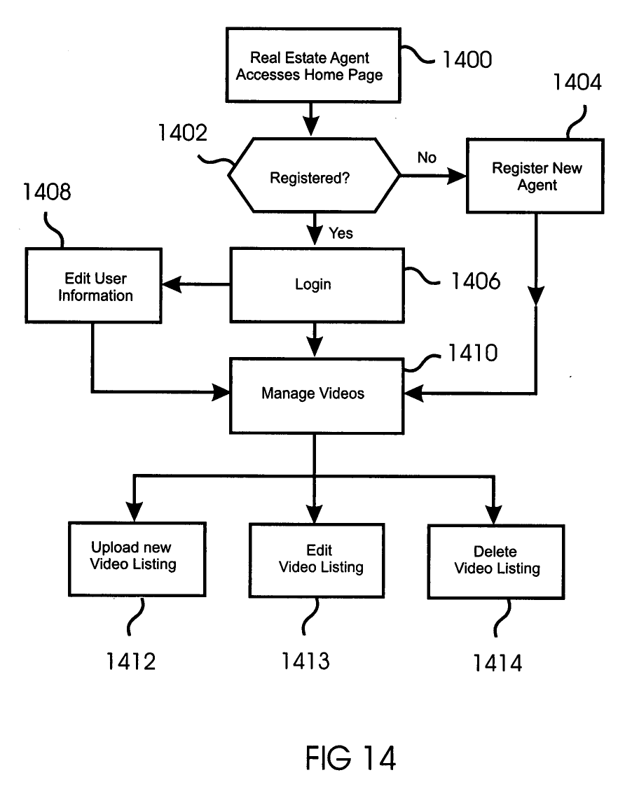

FIG. 14 presents a flow diagram indicating how administrative web pages of the website allow real estate agents to register as subscribers, log into the website, manage videos and perform other administrative tasks. A real estate agent begins by accessing the home page of the website 1400. Depending on whether the agent is already registered 1402, the agent registers as a new subscriber 1404 or logs in 1406. Upon logging in, an existing subscriber is offered the opportunity to edit his user information 1408 before continuing to the menu for managing videos 1410. A new or existing subscriber is then given the opportunity to upload new video listings and supporting information, edit existing video listings, or delete a video listing. In embodiments not limited to real estate, similar steps are followed by any user wishing to become a subscriber, and for subscribers to perform administrative tasks.

Other modifications and implementations will occur to those skilled in the art without departing from the spirit and the scope of the invention as claimed. Accordingly, the above description is not intended to limit the invention except as indicated in the following claims.

What is claimed is:

1. A website for facilitating access to videos relating to places of interest located within a region of interest, the website comprising:
a database containing only videos related to places of interest and supporting information relating to the videos;
a home webpage for searching the database, the home webpage including a first restricted input field for inputting location information and a second restricted input field for inputting search criteria specifying at least one specific characteristic relating to places of interest; and
a second webpage linked from the home webpage that displays a list of places of interest from the database as selected according to the location information and the at least one specific characteristic.

2. The website of claim 1, wherein the supporting information includes video information about providers of videos related to places of interest.

3. The website of claim 2, further comprising at least one webpage that displays the video information about providers of videos related to places of interest.

4. The website of claim 1, wherein the places of interest are at least one of homes for sale, homes for rent, hotels, restaurants, schools, museums, tourist attractions, shopping malls, supermarkets, retail stores, and other places of interest.

5. The website of claim 1, wherein the location information is at least one of a zip code, a town and state, and a city and state.

6. The website of claim 1, wherein the home webpage includes at least one input field for specifying a distance, and wherein the region of interest is defined as all locations that lie within the specified distance of at least one of a zip code, a town and state, a city and state, an address, a latitude and longitude, and other information entered by a user that defines one of a location and a region;

7. The website of claim 1, wherein the home webpage includes at least one input field for specifying a travel time, and wherein the region of interest is defined as all locations that lie within the specified travel time of at least one of a zip code, a town and state, a city and state, an address, a latitude and longitude, and other information entered by a user that defines one of a location and a region;

8. The website of claim 1, wherein the second webpage includes at least one restricted input field for inputting search criteria specifying at least one specific characteristic relating to places of interest, so as to provide for selecting places of interest from the database according to the location information and the at least one specific characteristic input on the home webpage and the at least one specific characteristic input on the second webpage.

9. The website of claim 1, further comprising at least one webpage that displays at least one of:
a video related to a place of interest selected by a user;
locating information that enables a user to locate a place of interest;
information about a real estate agent who has provided a video related to a place of interest to the database;
information about a subscriber who has provided a video related to a place of interest to the database; and
a video about to a subscriber who has provided a video related to a place of interest to the database.

10. The website of claim 1, further comprising at least one administrative web page, the administrative web pages providing input fields that enable individuals to register as subscribers, and enable subscribers to log into the website and to upload, add to, delete from, and edit videos in the database and supporting information applicable to the videos.

11. The website of claim 1, further comprising at least one web page that provides a list of other places of interest for which related videos are available in the database when a user selects one location of interest for which a related video is available in the database.

12. The website of claim 1, further comprising provisions for allowing a video contained in the database to be at least one of embedded in and linked to at least one of another website, a blog, an email, an MLS listing, and other electronic postings and communications.

13. A website for facilitating access to videos relating to places of interest located within a region of interest, the website comprising:
a database containing only videos related to places of interest and supporting information relating to the videos;
a home webpage for searching the database, the home webpage including only a restricted input field for inputting location information; and
a second webpage linked from the homepage that displays a list of places of interest from the database as selected according to the location information.

14. The website of claim 13, wherein the supporting information includes video information about providers of videos related to places of interest.

15. The website of claim 14, further comprising at least one webpage that displays the video information about providers of videos related to places of interest.

16. The website of claim 13, wherein the places of interest are at least one of homes for sale, homes for rent, hotels, restaurants, schools, museums, tourist attractions, shopping malls, supermarkets, retail stores, and other places of interest.

17. The website of claim 13, wherein the location information is at least one of a zip code, a town and state, and a city and state.

18. The website of claim 13, wherein the home webpage includes at least one input field for specifying a distance, and wherein the region of interest is defined as all locations that lie within the specified distance of at least one of a zip code, a town and state, a city and state, an address, a latitude and longitude, and other information entered by a user that defines one of a location and a region;

19. The website of claim 13, wherein the home webpage includes at least one input field for specifying a travel time, and wherein the region of interest is defined as all locations that lie within the specified travel time of at least one of a zip code, a town and state, a city and state, an address, a latitude and longitude, and other information entered by a user that defines one of a location and a region;

20. The website of claim 13, wherein the second webpage includes at least one restricted input field for inputting search criteria specifying at least one specific characteristic relating to places of interest, so as to provide for selecting places of interest from the database according to the location information and the at least one specific characteristic input on the home webpage and the at least one specific characteristic input on the second webpage.

21. The website of claim 13, further comprising at least one webpage that displays at least one of:
a video related to a place of interest selected by a user;
locating information that enables a user to locate a place of interest;
information about a real estate agent who has provided a video related to a place of interest to the database;
information about a subscriber who has provided a video related to a place of interest to the database; and
a video about to a subscriber who has provided a video related to a place of interest to the database.

22. The website of claim 13, further comprising at least one administrative web page, the administrative web pages providing input fields that enable individuals to register as subscribers, and enable subscribers to log into the website and to upload, add to, delete from, and edit videos in the database and supporting information applicable to the videos.

23. The website of claim 13, further comprising at least one web page that provides a list of other places of interest for which related videos are available in the database when a user selects one location of interest for which a related video is available in the database.

24. The website of claim 13, further comprising provisions for allowing a video contained in the database to be at least one of embedded in and linked to at least one of another website, a blog, an email, an MLS listing, and other electronic postings and communications.
